(19) United States
(12) Patent Application Publication
(10) Pub. No.: US 2012/0048402 A1
(43) Pub. Date: Mar. 1, 2012

(54) CONSTANT PRESSURE VALVE USED IN A HIGH PRESSURE CYLINDER

(76) Inventor: Yeh Hui Huang, Dajia Township (TW)

(21) Appl. No.: 12/872,741

(22) Filed: Aug. 31, 2010

(51) Int. Cl. F16K 15/00

(52) U.S. Cl. 137/535

(57) ABSTRACT

A constant pressure valve used in a high pressure cylinder contains a body including an inlet end, a channel, and an outlet end; a control structure being comprised of a controlling shaft, a sleeve member, and a rotary handle; an explosion protection valve disposed in the channel; a pressure displayer mounted in the channel; an air inflow member secured in the channel; a constant pressure output member including a check element abutted against by a resilient element and a spring to push a constant pressure column, the channel including a second opening formed on a predetermined position thereof ahead of the constant pressure column; wherein the channel is connected with the explosion protection valve, the controlling shaft, the pressure displayer, the air inflow member, and the constant pressure output member, and the channel includes a first opening formed on a front end of the controlling shaft.

### BACKGROUND OF THE INVENTION

1. Field of the Invention

The present invention relates to a constant pressure valve used in a high pressure cylinder that is capable of replacing another air bottle in the air supply equipment easily and safely, and the service lift of the air supply equipment and the safety valve is prolonged.

2. Description of the Prior Art

Conventional constant pressure valve used in a high pressure cylinder is replaced in at a high pressure, thus causing danger because screws of a screwing structure is easy to break, because during the air bottle is screwed with a nut of a paintball gun, a pushing element in the nut pushes an constant pressure output element, so that when high pressure air releases from the air bottle, a released pressure stores in the nut, and the air bottle and a constant pressure valve are difficult to screw with and remove from the nut, e.g., a rotating force has to be larger than the released pressure to lower a service life of the paintball gun and the constant pressure valve.

The present invention has arisen to mitigate and/or obviate the afore-described disadvantages.

### SUMMARY OF THE INVENTION

The primary object of the present invention is to provide a constant pressure valve used in a high pressure cylinder that is capable of overcoming the shortcomings of the conventional constant pressure valve used in a high pressure cylinder.

Another object of the present invention is to provide a constant pressure valve used in a high pressure cylinder that is capable of replacing another air bottle in the air supply equipment easily and safely, and the service lift of the air supply equipment and the safety valve is prolonged.

A constant pressure valve used in a high pressure cylinder in accordance with a preferred embodiment of the present invention comprises:
a body including an inlet end, a channel, and an outlet end, the inlet end being connected to an air bottle, and the outlet end being connected to a nut and a pushing element of an air supply equipment;
a control structure being comprised of a controlling shaft, a sleeve member, and a rotary handle, wherein the controlling shaft is fixed in the channel of the body, the sleeve member is fitted to the controlling shaft and further screwed with the body, the controlling shaft is connected with the rotary handle;
an explosion protection valve disposed in the channel of the body;
a pressure displayer mounted in the channel of the body;
an air inflow member secured in the channel of the body;
a constant pressure output member including a check element abutted against by a resilient element and a spring to push a constant pressure column disposed on the channel, the channel including a second opening formed on a predetermined position thereof ahead of the constant pressure column, and a bottom end of the constant pressure column is pushed by another end of the resilient element, the check element is limited in a cover which is screwed with the outlet end of the body, and the cover is adjustably rotated to set an air outflow pressure that is not equal to a pressure of the air bottle, and the check element closes the outlet end of the body;
wherein the body includes the channel connected with the explosion protection valve, the controlling shaft, the pressure displayer, the air inflow member, and the constant pressure output member, and the channel includes a first opening formed on a front end of the controlling shaft, the inlet end of the body is fixed on the air bottle, and then the rotary handle is rotated tightly so that the sealing member of the controlling shaft closes the first opening of the channel.

### BRIEF DESCRIPTION OF THE DRAWINGS

FIG. 1 is a perspective showing the exploded components of a constant pressure valve used in a high pressure cylinder in accordance with a preferred embodiment of the present invention;

FIG. 2 is a perspective showing the assembly of the constant pressure valve used in the high pressure cylinder in accordance with the preferred embodiment of the present invention;

FIG. 3 is a cross sectional showing the assembly of the constant pressure valve used in the high pressure cylinder in accordance with the preferred embodiment of the present invention;

FIG. 4 is a plan side showing the operation of the constant pressure valve used in the high pressure cylinder in accordance with the preferred embodiment of the present invention;

FIG. 5 is a cross sectional showing the operation of the constant pressure valve used in the high pressure cylinder in accordance with the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

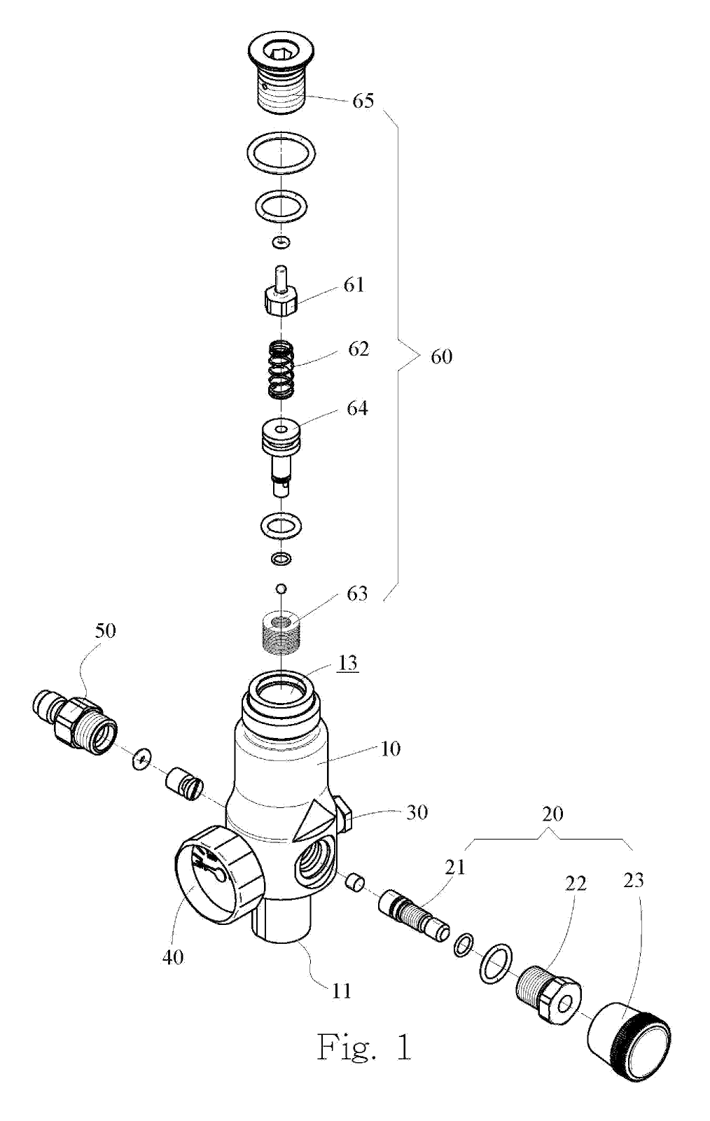

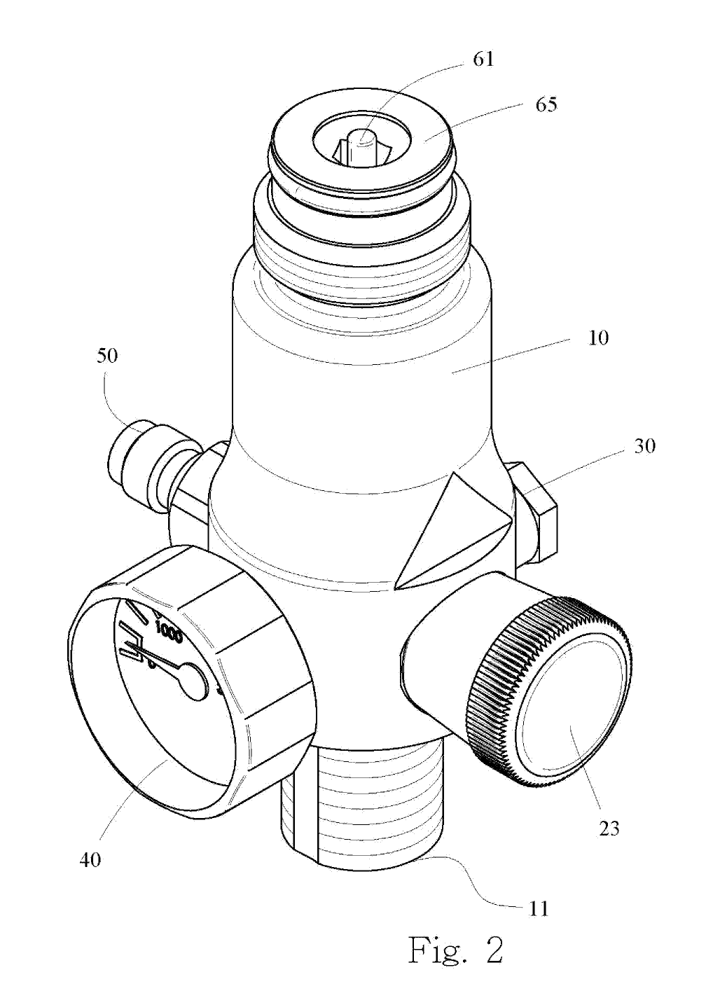

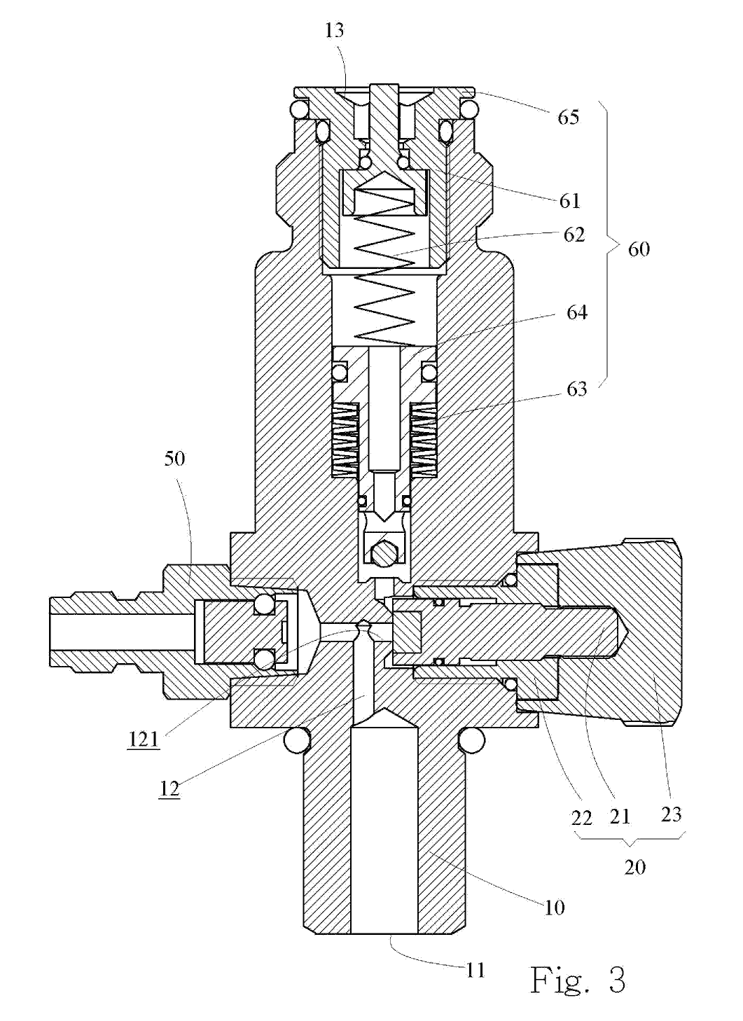

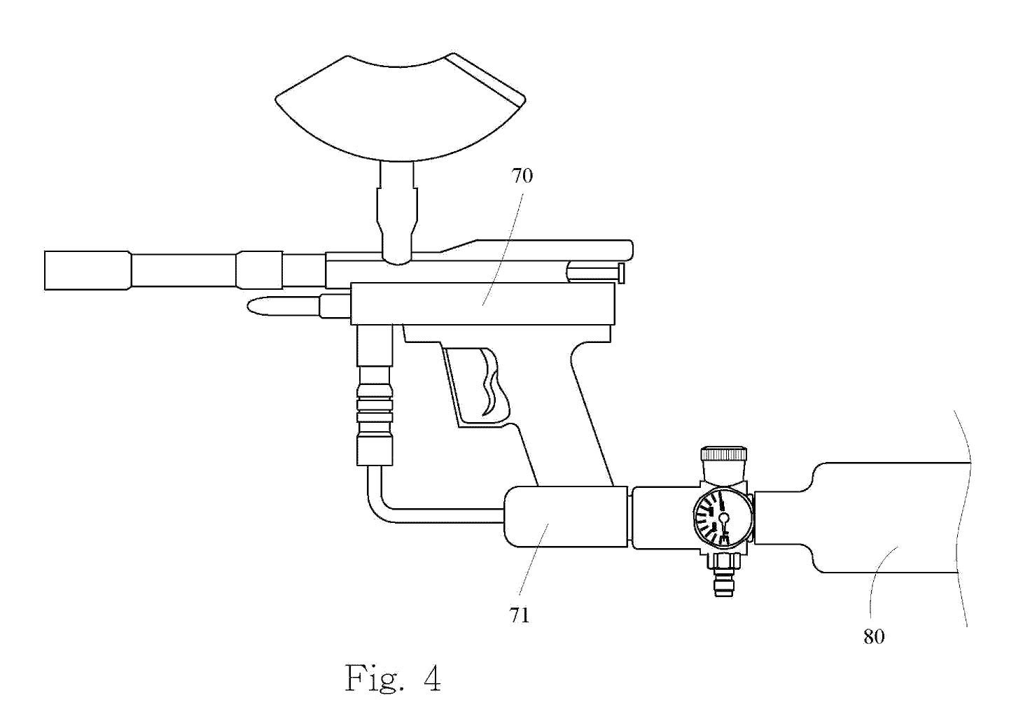

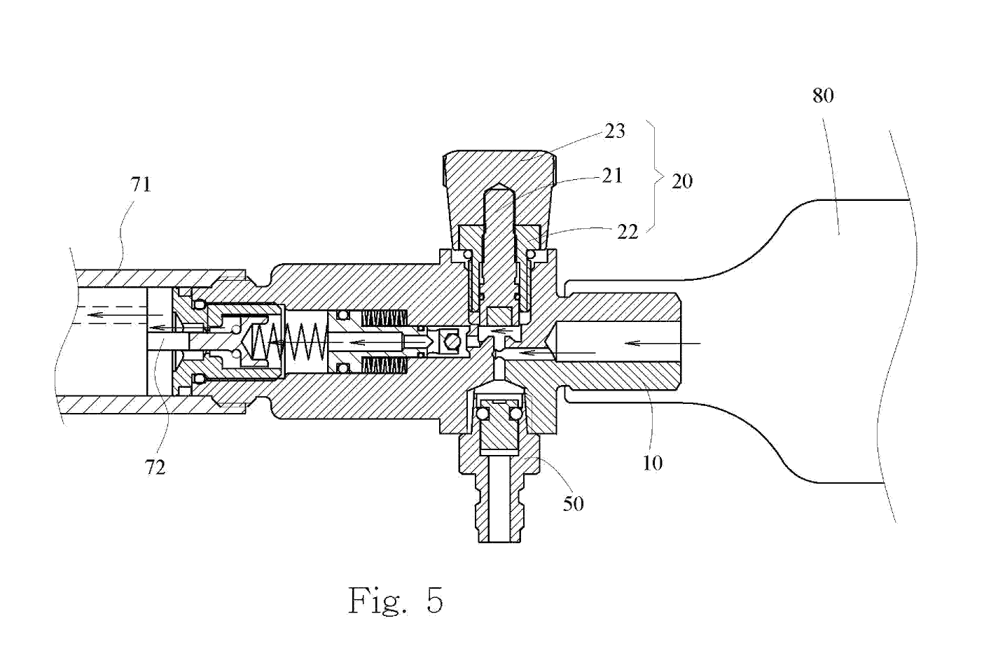

Referring to FIGS. 1-5, a constant pressure valve used in a high pressure cylinder according to a preferred embodiment of the present invention comprises:
a body 10 including an inlet end 11, a channel 12, and an outlet end 13, the inlet end 11 being connected to an air bottle 80, and the outlet end 13 being connected to a nut 71 and a pushing element 72 of an air supply equipment 70, wherein the air supply equipment 70 is a paintball gun;
a control structure 20 being comprised of a controlling shaft 21, a sleeve member 22, and a rotary handle 23, wherein the controlling shaft 21 is fixed in the channel 12 of the body 10, the sleeve member 22 is fitted to the controlling shaft 21 and further screwed with the body 10, the controlling shaft 21 is connected with the rotary handle 23;
an explosion protection valve 30 disposed in the channel 12 of the body 10;
a pressure displayer 40 mounted in the channel 12 of the body 10;
an air inflow member 50 secured in the channel 12 of the body 10;
a constant pressure output member 60 including a check element 61 abutted against by a resilient element 62 and a spring 63 to push a constant pressure column 64 disposed on the channel 12, the channel 12 including a second opening 122 formed on a predetermined position thereof ahead of the constant pressure column 64, and a bottom end of the constant pressure column 64 is pushed by another end of the resilient element 62, the check element 61 is limited in a cover 65 which is screwed with the outlet end 13 of the body 10, and the cover 65 is adjustably rotated to set an air outflow pressure that is not equal to a pressure of the air bottle 80, and the check element 61 closes the outlet end 13 of the body 10;
wherein the body 10 includes the channel 12 connected with the explosion protection valve 30, the controlling shaft 21, the pressure displayer 40, the air inflow member 50, and the constant pressure output member 60, and the channel 12 including a first opening 121 formed on a front end of the controlling shaft 21, the controlling shaft 21 includes a soft sealing member 211 disposed on a front end thereof, the inlet end 11 of the body 10 is fixed on the air bottle 80, and then the rotary handle 23 is rotated tightly so that the sealing member 211 of the controlling shaft 21 closes the first opening 121 of the channel 12, such that no air pressure exists in the outlet end 13 to be screwed with the nut 71 and the pushing 72 of the air supply equipment 70, thus preventing excessive pressure from stopping a screwing operation and enhancing safety, and a service lift of the air supply equipment 70 and the safety valve is prolonged.

Thereby, the channel 12 of the body 10 includes the first opening 121 and the controlling shaft 21 to be turned on or off to open or close the first opening 121, when the controlling shaft 21 is turned off, the first opening 121 is closed by the controlling shaft 21 to further close the channel 12 so that when the air bottle 80 is replaced, an high pressure air is not released to generate a resistance, thus replacing another air bottle 80 in the air supply equipment 70 easily and safely, and the service lift of the air supply equipment 70 and the safety valve is prolonged.

While we have shown and described various embodiments in accordance with the present invention, it is clear to those skilled in the art that further embodiments may be made without departing from the scope of the present invention.

What is claimed is:

1. A constant pressure valve used in a high pressure cylinder comprising:
a body including an inlet end, a channel, and an outlet end, the inlet end being connected to an air bottle, and the outlet end being connected to a nut and a pushing element of an air supply equipment;
a control structure being comprised of a controlling shaft, a sleeve member, and a rotary handle, wherein the controlling shaft is fixed in the channel of the body, the sleeve member is fitted to the controlling shaft and further screwed with the body, the controlling shaft is connected with the rotary handle;
an explosion protection valve disposed in the channel of the body;
a pressure displayer mounted in the channel of the body;
an air inflow member secured in the channel of the body;
a constant pressure output member including a check element abutted against by a resilient element and a spring to push a constant pressure column disposed on the channel, the channel including a second opening formed on a predetermined position thereof ahead of the constant pressure column, and a bottom end of the constant pressure column is pushed by another end of the resilient element, the check element is limited in a cover which is screwed with the outlet end of the body, and the cover is adjustably rotated to set an air outflow pressure that is not equal to a pressure of the air bottle, and the check element closes the outlet end of the body;
wherein the body includes the channel connected with the explosion protection valve, the controlling shaft, the pressure displayer, the air inflow member, and the constant pressure output member, and the channel includes a first opening formed on a front end of the controlling shaft, the inlet end of the body is fixed on the air bottle, and then the rotary handle is rotated tightly so that the sealing member of the controlling shaft closes the first opening of the channel.

2. The constant pressure valve used in the high pressure cylinder as claimed in claim 1, wherein the air supply equipment is a paintball gun.

3. The constant pressure valve used in the high pressure cylinder as claimed in claim 1, wherein the controlling shaft includes a soft sealing member disposed on a front end thereof
